(19) United States
(12) Patent Application Publication
(10) Pub. No.: US 2026/0251620 A1
(43) Pub. Date: Aug. 27, 2026

(54) DUAL ACOUSTIC ARRAY MONOBLOCK WEDGE

(71) Applicant: Evident Canada, Inc., Quebec (CA)

(72) Inventor: William Goulet, Québec (CA)

(73) Assignee: Evident Canada, Inc., Quebec (CA)

(21) Appl. No.: 19/549,710

(22) Filed: Feb. 25, 2026

Related U.S. Application Data
(60) Provisional application No. 63/763,709, filed on Feb. 26, 2025.

(51) Int. Cl. G01N 29/24; B23K 26/352; G01N 29/04

(52) U.S. Cl. CPC G01N 29/24; B23K 26/352; G01N 29/04; G01N 2291/023; G01N 2291/106

(57) ABSTRACT

An acoustic probe assembly can use an acoustic coupling wedge structure having an acoustically attenuating region integrated with the wedge structure, such as for use with a Dual Linear Array (DLA) transducer configuration or other acoustic inspection probe configurations. The acoustically attenuating region can be formed in the wedge structure such as using laser-based modification of the wedge structure subsurface. For example, subsurface laser engraving can be used to form a pattern (e.g., an array of cavities, bubbles, or regions otherwise having different acoustic propagation characteristics than a surrounding bulk of the wedge material).

### CROSS REFERENCE TO RELATED APPLICATION

This application claims the benefit of priority under 35 U.S.C. § 119(e) to U.S. Provisional Patent Application No. 63/763,709, filed on February 26, 2025, the entire disclosure of which is hereby incorporated by reference in its entirety.

### BACKGROUND

### Technical Field

This document pertains generally, but not by way of limitation, to non-destructive evaluation, and more particularly, to apparatus and techniques for providing an acoustic coupling wedge structure facilitating non-destructive inspection, such as phased-array ultrasonic testing (PAUT).

### Discussion of Art

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include values from, for example, a few hundred kilohertz, to tens of megahertz, as an illustrative example.

### SUMMARY

In one aspect, the present disclosure provides acoustic inspection probe assembly. The probe assembly may include a transducer assembly and a monolithic wedge structure. The transducer assembly may include a first linear array of transducer elements to transmit acoustic energy and a second linear array of transducer elements to receive acoustic energy. The monolithic wedge structure may couple acoustic energy between the transducer assembly and a test object. The monolithic wedge structure may include a transmitting region to refract acoustic energy from the first array into the test object, a receiving region to refract acoustic energy received from the test object toward the second array, and an intermediate region for attenuating propagation of acoustic energy through the monolithic wedge structure between the transmitting region and the receiving region.

In one aspect, the present disclosure provides wedge structure for coupling acoustic energy between a transducer assembly of an acoustic inspection probe assembly and a test object. The wedge structure may be a monolithic structure formed from a transparent material. The wedge structure may include a transmitting region to refract acoustic energy from a first array of the transducer assembly into the test object, a receiving region to refract acoustic energy received from the test object toward a second array of the transducer assembly, and an intermediate region for attenuating propagation of acoustic energy through the monolithic wedge structure between the transmitting region and the receiving region. The intermediate region may be defined by at least one cavity formed in the transparent material.

In one aspect, the present disclosure provides a method of fabricating an acoustic inspection probe assembly. The method may include modifying a subsurface of a wedge structure using a laser to form a region intermediate a transmitting region and a receive region. The wedge structure may be a monolithic transparent material. The method may include coupling the wedge structure to a transducer assembly comprising a first linear array of transducer elements and a second linear array of transducer elements.

### BRIEF DESCRIPTION OF THE DRAWINGS

FIGS. 1A and 1B show examples of acoustic probe assemblies having separate wedge portions and a gap, according to at least one embodiment of the present disclosure.

FIG. 2 shows a bottom view of an acoustic probe assembly having separate wedge portions and a gap, according to at least one embodiment of the present disclosure.

FIG. 3 shows a schematic side view of an acoustic probe assembly having wedge portions and a gap, according to at least one embodiment of the present disclosure.

FIGS. 4A-4F show schematic side views of wedge structures that can include different patterned cavity regions to form an acoustically-attenuating region in the middle of the wedge structure, according to at least one embodiment of the present disclosure.

FIG. 5 shows a perspective view of a probe assembly, according to at least one embodiment of the present disclosure.

FIG. 6 illustrates a method of fabricating an acoustic inspection probe assembly, according to at least one embodiment of the present disclosure.

### DESCRIPTION

Acoustic testing, such as ultrasound-based inspection, can include focusing or beam-forming techniques to aid in the construction of data plots or images representing a region of interest within the test specimen. Use of an array of ultrasound transducer elements can include use of a phased-array beamforming approach and can be referred to as Phased Array Ultrasound Testing (PAUT). In one approach, two acoustic transducer arrays can be acoustically coupled with an acoustic coupling wedge assembly to facilitate a pitch/catch measurement scheme where elements in one of the two acoustic transducer arrays can be used to generate an acoustic transmission, and elements in the other acoustic transducer array can be used to receive scattered or reflected acoustic energy (e.g., echoes) in response to the acoustic transmission.

As an example, two separate linear arrays of acoustic elements can be mechanically anchored to an acoustic coupling wedge assembly. Such a configuration can be referred to as a Dual Linear Array (DLA) probe assembly. Such a probe assembly can be used, for example, to perform acoustic inspection of weld structures or for other applications. Generally available acoustic coupling wedge structures are fabricated using separate structures that are mechanically anchored together, such as separate acoustic wedge structures that are mounted together, separated by a gap structure to inhibit acoustic coupling across the wedge between the acoustic transducer arrays.

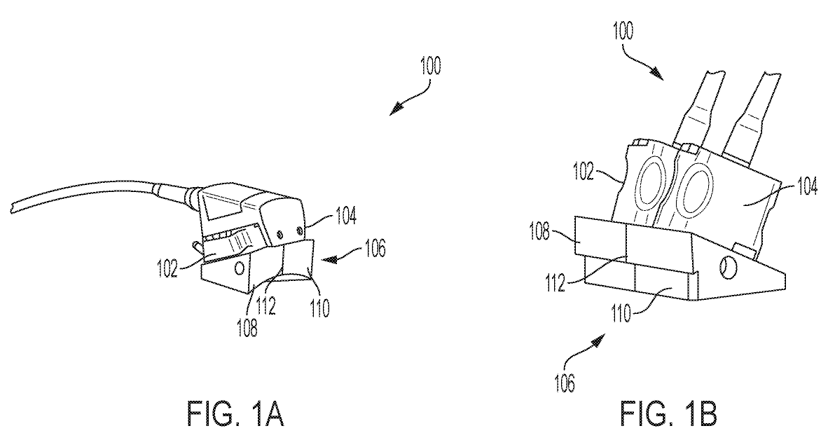

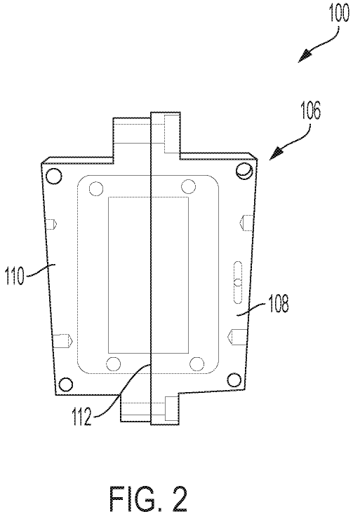

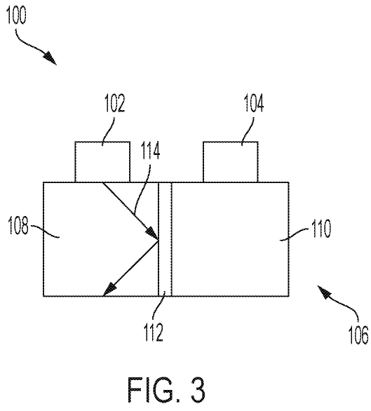

FIGS. 1A and 1B show examples of acoustic probe assemblies 100 having separate wedge portions and a gap. FIG. 2 shows an example of an active surface (e.g., emitting or receiving surface) of an acoustic probe assembly having separate wedge portions and a gap. FIG. 2 may represent a bottom view of an acoustic probe assembly according to FIGS. 1A or 1B. FIG. 3 shows a schematic side view of an acoustic probe assembly showing wedge portions and a gap, with separate transducer arrays at the top of the wedge structure, such as the acoustic probe assemblies of FIGS. 1A and 1B.

The probe assemblies 100 include a first array 102 of transducer elements and a second array of transducer elements 104. The probe assemblies include a wedge assembly 106 that has a first wedge portion 108 and a separate second wedge portion 110. These wedge portions are separated by a gap 112 positioned between the transmitting and receiving regions of the wedge assembly.

The gap 112 may include a material designed to inhibit acoustic transmission between the two wedge portions. This material can be a sound-dampening element such as cork, foam, or similar attenuating material. This material is compressed between the wedge portions to form a barrier that reduces cross talk by absorbing or scattering acoustic energy traveling through the wedge structure.

The first wedge portion may transmit acoustic energy 114 from the first array toward the test object, while the second wedge portion may receive acoustic energy reflected or scattered from the test object and direct it toward the second array. The gap between the wedge portions functions as an acoustic isolator, attenuating propagation of acoustic energy from the transmitting region (corresponding to the first wedge portion) to the receiving region (corresponding to the second wedge portion).

As shown in FIG. 3, the gap is illustrated reflecting acoustic energy transmitted by the first array and traveling through the first wedge portion. The gap can attenuate this energy from entering the second wedge portion, thereby reducing unwanted signal transmission and improving the signal-to-noise ratio of the received data.

As an illustrative example, the gap can be about 0.1 mm wide, separating the two wedge portions in the middle of the probe assembly (shown in the assembly of FIG. 3 above as a line bifurcating the wedges in the center). The 0.1 mm-wide gap width approaches a physical limit for the mechanical tolerances of a two-wedge structure.

According to various aspects of the present subject matter, an acoustic probe assembly can use an acoustic coupling wedge structure having an acoustically-attenuating region integrated with the wedge structure, such as for use with a DLA transducer configuration or other acoustic inspection probe configurations.

For example, according to various embodiments, the present disclosure provides a wedge structure for use with an acoustic inspection probe assembly. The probe assembly may include a transducer assembly that incorporates a first linear array of transducer elements, which may transmit acoustic energy, and a second linear array of transducer elements, which may receive acoustic energy. The wedge structure may serve as an acoustic interface between the transducer assembly and a test object, facilitating the transmission and reception of acoustic energy with a test object.

This wedge structure may be formed from a single, unitary piece of material, resulting in a monolithic wedge structure. Within the monolithic wedge, there may be a transmitting region for refracting acoustic energy from the first array into the test object, a receiving region for refracting acoustic energy received from the test object toward the second array, and an intermediate region (e.g., an acoustic attenuation region) that may attenuate propagation of acoustic energy through the wedge between the transmitting and receiving regions.

The acoustic coupling wedge structure can be fabricated from materials similar to generally available wedge structures, such as Rexolite 1422. Rexolite 1422 is a transparent polymer material, and more specifically, a transparent, thermoset, cross-linked polystyrene material. Other suitable transparent polymer wedge structure materials may include other cross-linked polystyrene materials (e.g., Rexolite 2200), polymethyl methacrylate, polycarbonate, styrene methyl methacrylate, cyclic olefin copolymers, fluorinated ethylene propylene, and transparent polypropylene.

The acoustically attenuating region (e.g., the intermediate region) can be formed in the wedge structure such as using a laser-based modification process such as subsurface laser engraving and/or laser etching. For example, subsurface laser engraving can be used to form a pattern (e.g., an array of cavities, bubbles, or regions otherwise having different acoustic propagation characteristics than a surrounding bulk of the wedge material). For example, using laser precision, an attenuation pattern can be engraved within the material to form an acoustic isolator structure or “gap” having features at the micron level (much smaller than the 0.1-mm structure mentioned above in the case of a multi-piece mechanical assembly), where such a smaller integrated isolator can reduce signal interference, such as between transmit and receive arrays, and improve the quality of the ultrasonic signals. Generally, by creating this micron-level gap, a laser-engraved pattern can attenuate the signal in a specific locus or spatial region within the wedge structure.

In various embodiments, the laser‑based modification process may employ any suitable class of laser technology capable of producing localized subsurface cavities or material modifications within the wedge structure. Such techniques may include ultraviolet (UV) lasers, infrared (IR) lasers, visible‑spectrum lasers, femtosecond or picosecond ultrafast lasers, or other laser systems having sufficient photon energy and/or pulse characteristics to modify a subsurface of the wedge structure for forming an acoustically attenuating region (e.g., the intermediate region).

The attenuation pattern can be formed comprising small cavities, such as created by a laser. The cavities can be formed in a plane or can extend three-dimensionally, such as including cavity structures or groups of cavity structures having triangular, pyramidal, or spherical shapes, as examples. For example, a diffusing structure can be formed such as having pyramidal shape or triangular-profiled cavities or groups of cavities.

In various embodiments, the intermediate region may attenuate acoustic propagation between the transmitting and refracting regions by creating an acoustic impedance mismatch relative to the surrounding material of the monolithic wedge structure. For example, cavities, voids, or other subsurface features formed within the intermediate region may include air, a partial vacuum, and/or another low-impedance medium that exhibit a lower acoustic impedance than the adjacent wedge structure material. This impedance mismatch may cause incident acoustic energy to be reflected, scattered, or otherwise disrupted within the intermediate region, thereby attenuating transmission of acoustic energy between the transmitting region and the receiving region.

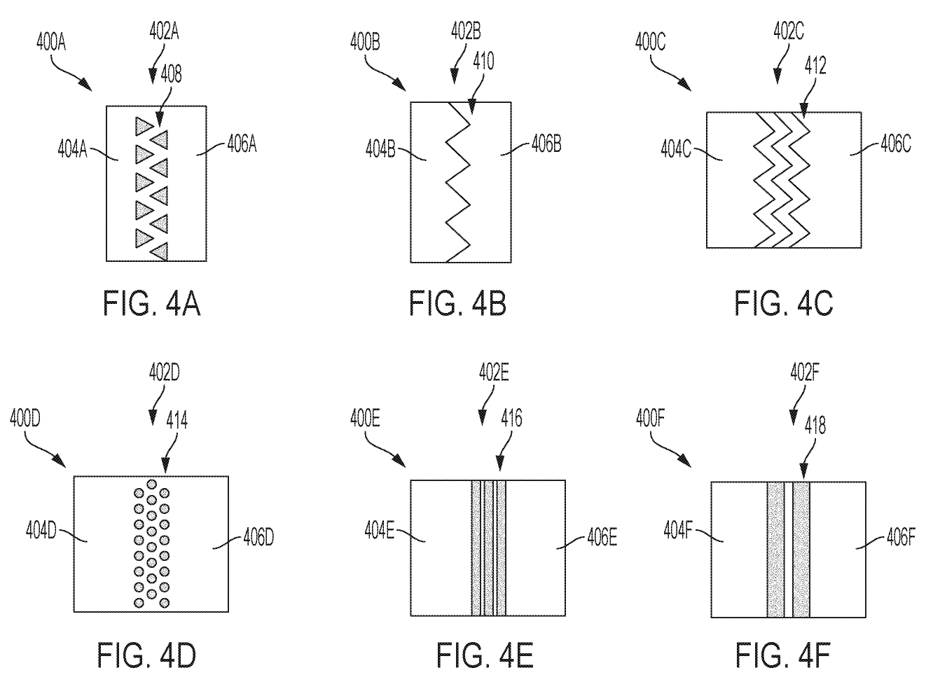

FIGS. 4A-4F show side views of wedge structures that can include different patterned cavity regions to form an acoustically-attenuating region in the middle of the wedge structure (e.g., intermediate region). The acoustically-attenuating region can be used instead of mechanical gap of the acoustic probe assembly of FIG. 2.

FIG. 4A shows a side view of a wedge structure 400A including an intermediate region 402A with triangular shaped tubes 408. The triangular shaped tubes are arranged in a pattern extending along a plane between a transmitting region 404A and a receiving region 406A. The tubes extend along a depth of the wedge structure to provide acoustic attenuation between the transmitting and receiving regions.

FIG. 4B shows a side view of a wedge structure 400B including an intermediate region 402B with a non-linear attenuation pattern 410. The non-linear attenuation pattern has a zig-zag profile that extends along a plane between a transmitting region 404B and a receiving region 406B and extends along a depth of the wedge structure to provide acoustic attenuation between the transmitting and receiving regions. The non-linear attenuation pattern may include a plurality of small voids or cavities formed via laser-based subsurface modification of the wedge structure.

FIG. 4C shows a side view of a wedge structure 400C including an intermediate region 402C with more than one non-linear attenuation pattern 412. Each non-linear attenuation pattern has a zig-zag profile that extends along a corresponding plane between a transmitting region 404C and a receiving region 406C and extends along a depth of the wedge structure to provide acoustic attenuation between the transmitting and receiving regions. Each non-linear attenuation pattern may include a plurality of small voids or cavities formed via laser engraving of the wedge structure. FIG. 4C shows three non-linear attenuation patterns, but other implementations may include two non-linear attenuation patterns or more than three non-linear attenuation patterns.

FIG. 4D shows a side view of a wedge structure 400D including an intermediate region 402D with circular tubes 414. The circular tubes are arranged in a pattern extending along a plane between a transmitting region 404D and a receiving region 406D. The tubes extend along a depth of the wedge structure to provide acoustic attenuation between the transmitting and receiving regions.

FIG. 4E shows a side view of a wedge structure 400E including an intermediate region 402E with more than one linear attenuation pattern 416. Each linear attenuation pattern extends along a plane between a transmitting region 404E and a receiving region 406E and extends along a depth of the wedge structure to provide acoustic attenuation between the transmitting and receiving regions. Each linear attenuation pattern may include a plurality of small voids or cavities formed via laser-based subsurface modification of the wedge structure.

FIG. 4F shows a side view of a wedge structure 400F including an intermediate region 402F with more than one linear attenuation pattern 418. Each linear attenuation pattern extends along a corresponding plane between a transmitting region 404F and a receiving region 406F and extends along a depth of the wedge structure to provide acoustic attenuation between the transmitting and receiving regions. Each linear attenuation pattern may include a plurality of small voids or cavities formed via laser-based subsurface modification of the wedge structure. FIGS. 4E and 4F respectively show three and two linear attenuation patterns, but other implementations may include one linear attenuation pattern or more than three linear attenuation patterns.

Thus, in some embodiments, the intermediate region may include at least one cavity defined within the monolithic wedge structure. The cavity may be formed by removing or modifying material within the wedge, creating a localized region of reduced acoustic transmission. The intermediate region may include a plurality of discrete cavities formed within the monolithic wedge structure. These cavities may be arranged in patterns or distributed throughout the intermediate region to achieve the desired attenuation characteristics. The at least one cavity may define an attenuation pattern for attenuating the propagation of acoustic energy through the wedge between the transmitting and receiving regions.

In some embodiments, the intermediate region (e.g., including the attenuation pattern) may be aligned along a plane that intersects the monolithic wedge structure between the transmitting region and the receiving region. For example, at least one cavity defining the attenuation pattern may be defined along the plane. This alignment may be selected to maximize attenuation and minimize direct transmission of acoustic energy across the wedge.

In some embodiments, the intermediate region may include a plurality of discrete attenuation zones, each aligned along corresponding planes that intersect the wedge structure between the transmitting and receiving regions. For example, the intermediate region may include subsurface laser engraved patterns aligned along two or more parallel planes between the transmitting and receiving regions. Each of these zones may include one or more cavities. The zones may define an attenuation pattern for attenuating the propagation of acoustic energy through the wedge between the transmitting and receiving regions.

In some embodiments, the cavities within the intermediate region may include cylindrical, triangular, or square tubes patterned along a height of the intermediate region and extending along a length of the intermediate region. In other implementations, the cavities may include pyramidal, cubical, or spherical shapes arranged in one or more columns extending along a height of the intermediate region. In yet other implementations, the cavities may include voids randomly distributed across the intermediate region.

In some embodiments, at least a partial vacuum may exist within the cavity or cavities of the intermediate region that define an attenuation pattern. A partial vacuum refers to a condition where the pressure inside the cavity is lower than atmospheric pressure, but may not be a perfect vacuum. This may occur naturally during laser-based subsurface modification of the wedge structure or may be intentionally created during manufacturing. This acoustic impedance mismatch between the intermediate region and the adjacent wedge structure can cause acoustic energy to be reflected or scattered rather than transmitted across the intermediate region,, thereby reducing cross talk between the transmitting and receiving regions.

The monolithic wedge structure may include first and second transducer mounting surfaces for coupling to first and second linear arrays. The wedge structure may further include first and second refracting surfaces, respectively corresponding to the transmitting and receiving regions. These refracting surfaces may be shaped to direct acoustic energy into and from the test object, optimizing signal transmission and reception.

In various embodiments, the monolithic wedge structure may include a continuous object-facing surface that spans both the transmitting and receiving regions. The object-facing surface may include the first and second refracting surfaces, providing a seamless interface with the test object. This continuous surface may improve upon multi-piece wedge designs, which often have offsets or discontinuities between separate transmitting and receiving pieces. Such offsets can create gaps or uneven contact with the test object, leading to poor acoustic coupling and signal distortion. By eliminating these discontinuities, the monolithic design with a continuous object-facing surface and achieve uniform contact and consistent transmission of ultrasonic energy into the test object.

The probe assembly may include a probe housing for securing the first and second linear arrays to the respective transducer mounting surfaces in fixed positions relative to the monolithic wedge structure. The housing may be constructed from rigid or resilient materials to maintain alignment and protect the transducer elements. The probe housing may include features for facilitating attachment to inspection equipment, such as mounting brackets, alignment guides, or connectors for electrical and signal transmission.

The arrangement, geometry, and distribution of cavities or attenuation zones within the intermediate region may be determined through acoustic modeling, simulation, or experimental testing to achieve optimal isolation between the transmitting and receiving regions. The intermediate region may be engineered to provide a target level of acoustic attenuation, which may be evaluated by measuring signal-to-noise ratios during inspection of test objects at various depths.

The probe assembly may be used in conjunction with various coupling agents, such as gels or greases, to facilitate acoustic transmission between the transducer arrays and the wedge structure. Coupling agents may be materials applied to the interface between the transducer and the wedge to eliminate air gaps, which would otherwise reflect ultrasonic energy. Common examples include silicone-based gels, glycerin, or specialized ultrasonic couplants. These agents may be applied directly to the transducer mounting surfaces or to the contact area between the transducer and the wedge.

The wedge structure may be designed to accommodate different roof angles, which may be selected based on the desired refraction angle for the ultrasonic beam within the test object. A roof angle refers to the angular offset between the top surface of the wedge and the object-facing surface, and may specifically correspond to an angle representing rotation about an axis that is parallel to the probe assembly’s active axis. This angle determines how the ultrasonic beam refracts when entering the test object, allowing the operator to target specific regions or depths. For example, a smaller roof angle may be used for shallow inspections, while a larger angle may be used for deeper penetration or angled weld inspections. The transducer arrays may be arranged at specific angles or positions relative to the wedge structure to achieve focused or directed acoustic energy transmission and reception.

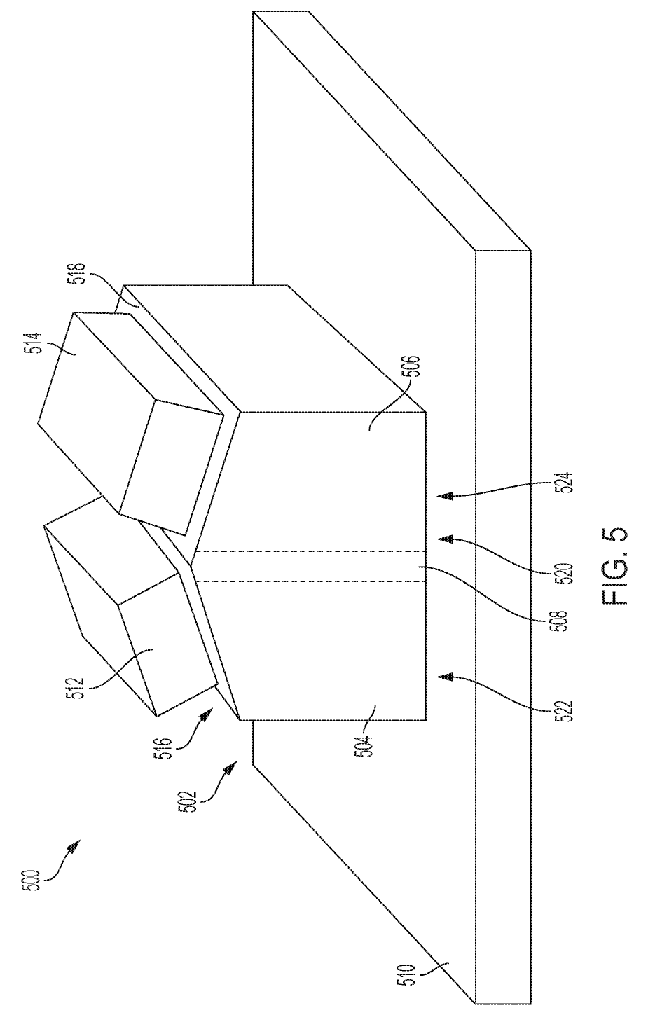

FIG. 5 shows an example implementation of a probe assembly 500. The probe assembly includes a wedge structure 502 having a transmitting region 504 for refracting acoustic energy toward a test object 510, a receiving region 506 for refracting acoustic energy received from the test object, and an intermediate region 508, such as an acoustic attenuation region, that may attenuate propagation of acoustic energy through the wedge between the transmitting and receiving regions.

The wedge structure may be a monolithic wedge. The intermediate region may be formed within the monolithic wedge using laser-based subsurface modification. This region may include one or more attenuation patterns designed to disrupt or block acoustic energy traveling directly between the transmitting and receiving regions. The attenuation patterns may include cavities, voids, or zones arranged in various configurations, such as linear patterns, non-linear zig-zag profiles, triangular or circular tubes, or three-dimensional shapes like pyramidal, cubical, or spherical cavities. In some implementations, multiple attenuation zones may be aligned along parallel planes. These cavities may be partially evacuated to create a vacuum or near-vacuum condition. Randomly distributed voids may be used to scatter acoustic energy and minimize cross talk.

The probe assembly may further include a first linear array 512 of transducer elements that may transmit acoustic energy and a second linear array 514 of transducer elements that may receive acoustic energy. These arrays may be mounted to the wedge structure using a probe housing that secures the arrays in fixed positions relative to the wedge. The wedge structure may include a first transducer mounting surface 516 for coupling to the first linear array and a second transducer mounting surface 518 for coupling to the second linear array. The mounting surfaces may provide flat or contoured regions to ensure proper alignment and acoustic coupling between the arrays and the wedge. The probe housing may include mechanical fasteners, alignment guides, or clamping features to maintain the arrays in position during operation and may also incorporate electrical connectors for signal transmission.

The wedge structure may include a continuous object-facing surface 520 that spans both the transmitting region and the receiving region. This continuous surface may include a first refracting surface 522 positioned adjacent the transmitting region and a second refracting surface 524 positioned adjacent the receiving region. The first refracting surface may be oriented to direct acoustic energy from the first linear array into the test object and the second refracting surface may be oriented to direct acoustic energy received from the test object toward the second linear array. By forming these refracting surfaces as part of a continuous object-facing surface, the wedge structure may provide uniform contact with the test object, reducing gaps or discontinuities that could occur in multi-piece wedge designs. This configuration may improve acoustic coupling and ensure consistent transmission and reception of ultrasonic signals across the entire inspection area.

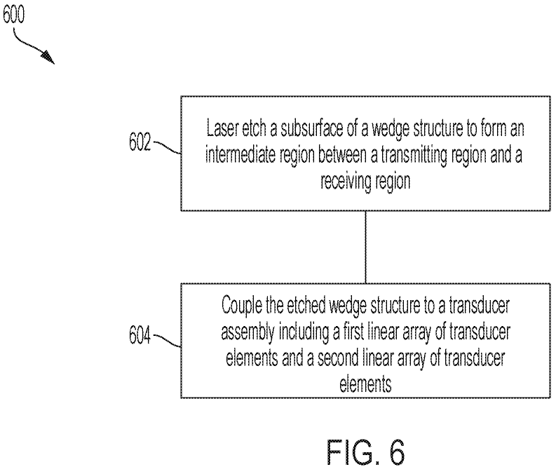

FIG. 6 illustrates a method 600 of fabricating an acoustic inspection probe assembly. Aspects of the method may be used for fabricating any of the probe and/or wedge embodiments disclosed herein. The method may include modifying 602 a subsurface of a wedge structure using a laser to form an intermediate region within the wedge structure between a transmitting region and a receiving region. For example, subsurface laser etching and/or subsurface laser engraving may be employed to modify the wedge structure. The wedge structure may be a monolithic transparent material, such as a polymer suitable for ultrasonic applications. The method may further include coupling 604 the wedge structure to a transducer assembly including a first linear array of transducer elements and a second linear array of transducer elements.

According to various embodiments of the method, modifying the subsurface of the wedge structure may include forming one or more attenuation patterns within the wedge structure. These patterns may include cavities, voids, or zones arranged to attenuate acoustic energy traveling between the transmitting and receiving regions. Example patterns may include linear grooves, zig-zag profiles, triangular or circular tubes, or three-dimensional shapes such as pyramidal, cubical, or spherical cavities. Multiple patterns may be aligned along parallel planes to increase isolation. Random void distributions may be used to scatter acoustic energy and minimize cross talk.

According to various embodiments of the method, coupling the etched wedge structure to the transducer assembly may include aligning the first linear array with the transmitting region and the second linear array with the receiving region. The transmitting region may direct acoustic energy from the first array into a test object, and the receiving region may direct acoustic energy received from the test object toward the second array. The intermediate region may function as an acoustic barrier to reduce signal interference between the arrays.

According to various embodiments of the method, the wedge structure may be fabricated from transparent polymer materials that allow subsurface laser-based modification. Suitable materials may include Rexolite 1422, other cross-linked polystyrene materials (e.g., Rexolite 2200), polymethyl methacrylate (PMMA), polycarbonate, styrene methyl methacrylate, cyclic olefin copolymers, fluorinated ethylene propylene, and transparent polypropylene.

According to various embodiments of the method, a couplant may be applied to facilitate acoustic coupling between the transducer elements and the wedge structure. Couplants may include gels, greases, or specialized ultrasonic coupling agents that eliminate air gaps at the interface. These materials may be applied to the transducer mounting surfaces of the wedge or directly to the transducer arrays to ensure efficient transmission of ultrasonic energy.

According to various embodiments of the method, the laser etching process may be controlled to achieve micron-level precision. Parameters such as laser power, pulse duration, and focal depth may be adjusted to create cavities without compromising the structural integrity of the wedge. Automated positioning systems may be used to ensure accurate placement of attenuation patterns within the intermediate region.

According to various embodiments of the method, a probe housing may be assembled for coupling the transducer arrays to the wedge structure. The housing may include alignment features, mechanical fasteners, and electrical connectors to secure the arrays and provide signal transmission. The housing may also incorporate protective elements to shield the transducer assembly from environmental conditions during use.

According to various embodiments of the method, quality control steps may be performed after fabrication. These steps may include visual inspection of the laser-etched patterns, verification of array alignment, and acoustic testing to confirm attenuation performance and signal-to-noise ratio. Calibration procedures may also be applied to ensure the probe meets inspection standards.

According to various embodiments of the method, finishing processes may be applied to the wedge structure. These may include polishing the object-facing surface to ensure smooth contact with the test object, applying surface treatments to improve durability, and/or adding identification markings for traceability.

Aspects of the approach described herein can reduce manufacturing complexity and cost. For example, a laser-based subsurface modification approach (e.g., etching or engraving) for forming an attenuation region within the wedge structure can replace generally available multi-part wedge structures with as few as a single, integrated wedge assembly, lowering production cost and improving acoustic performance. For example, a single-part wedge configuration reduces or eliminates a need for more-complex assembly processes, such as reducing both material and labor costs.

Aspects of the approach described herein can improve inspection quality. For example, a micron-level acoustic isolation “gap” produced by, for example, laser-based subsurface modification, can enhance acoustic performance such as by reducing noise or otherwise increasing a clarity of a transmitted signal or received echo. This can enhance inspection reliability such as providing higher resolution or improved signal-to-noise performance.

The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

The term “substantially”, “about”, or “approximately” as used in the present disclosure, unless otherwise specified, means an acceptable error for a particular value as determined by one of ordinary skill in the art, which depends in part on how the value is measured or determined. In certain embodiments, the term “substantially”, “about”, or “approximately” means within 10%, 9%, 8%, 7%, 6%, 5%, 4%, 3%, 2%, 1%, 0.5%, or 0.05% of a given value or range.

In the description, like reference characters designate like or corresponding parts throughout the several views of the drawings. Also in the description, it is to be understood that such terms as “forward,” “rearward,” “left,” “right,” “above,” “below,” “upwardly,” “downwardly,” and the like are words of convenience and are not to be construed as limiting terms.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. An acoustic inspection probe assembly, comprising:
a transducer assembly, comprising:
a first linear array of transducer elements configured to transmit acoustic energy; and
a second linear array of transducer elements configured to receive acoustic energy; and
a monolithic wedge structure configured to couple acoustic energy between the transducer assembly and a test object, the monolithic wedge structure comprising:
a transmitting region configured to refract acoustic energy from the first linear array into the test object;
a receiving region configured to refract acoustic energy received from the test object toward the second linear array; and
an intermediate region for attenuating propagation of acoustic energy through the monolithic wedge structure between the transmitting region and the receiving region.

2. The acoustic inspection probe assembly of claim 1, wherein the intermediate region is configured to create an acoustic impedance mismatch relative to the transmitting region and the receiving region to attenuate the propagation of acoustic energy.

3. The acoustic inspection probe assembly of claim 1, wherein the intermediate region is aligned along a plane intersecting the monolithic wedge structure intermediate the transmitting region and the receiving region.

4. The acoustic inspection probe assembly of claim 1, wherein the intermediate region comprises a plurality of discrete attenuation zones aligned along corresponding planes intersecting the monolithic wedge structure intermediate the transmitting region and the receiving region.

5. The acoustic inspection probe assembly of claim 1, wherein the intermediate region comprises a thickness of less than about 0.1 mm.

6. The acoustic inspection probe assembly of claim 1, wherein the intermediate region comprises at least one cavity defined in the monolithic wedge structure.

7. The acoustic inspection probe assembly of claim 6, wherein at least a partial vacuum exists in the at least one cavity.

8. The acoustic inspection probe assembly of claim 7, wherein the at least one cavity comprises a plurality of discrete cavities formed in the monolithic wedge structure.

9. The acoustic inspection probe assembly of claim 8, wherein the cavities comprise cylindrical, triangular, or square tubes patterned along a height of the intermediate region and extending along a length of the intermediate region.

10. The acoustic inspection probe assembly of claim 8, wherein the cavities comprise pyramidal, cubical, or spherical cavities arranged in one or more columns extending along a height of the intermediate region.

11. The acoustic inspection probe assembly of claim 8, wherein the cavities comprise voids randomly distributed across the intermediate region.

12. The acoustic inspection probe assembly of claim 1, wherein the monolithic wedge structure comprises a transparent polymer material.

13. The acoustic inspection probe assembly of claim 1, wherein the intermediate region is formed by subsurface modification of the monolithic wedge structure using a laser.

14. The acoustic inspection probe assembly of claim 1, wherein the monolithic wedge structure comprises a first transducer mounting surface and a second transducer mounting surface for respective coupling to the first linear array and the second linear array, and a first refracting surface and a second refracting surface respectively corresponding to the transmitting region and the receiving region for directing acoustic energy into and from the test object.

15. The acoustic inspection probe assembly of claim 14, wherein the monolithic wedge structure comprises a continuous object-facing surface spanning the transmitting region and the receiving region, and the object-facing surface comprises the first refracting surface and the second refracting surface.

16. The acoustic inspection probe assembly of claim 14, comprising a probe housing for securing the first linear array and the second linear array to the respective transducer mounting surfaces in fixed positions relative to the monolithic wedge structure.

17. A wedge structure for coupling acoustic energy between a transducer assembly of an acoustic inspection probe assembly and a test object, wherein the wedge structure is a monolithic structure formed from a transparent material, the wedge structure comprising:
a transmitting region configured to refract acoustic energy from a first array of the transducer assembly into the test object;
a receiving region configured to refract acoustic energy received from the test object toward a second array of the transducer assembly; and
an intermediate region for attenuating propagation of acoustic energy through the monolithic wedge structure between the transmitting region and the receiving region, wherein the intermediate region is defined by at least one cavity formed in the transparent material.

18. The wedge structure of claim 17, wherein the intermediate region comprises a thickness of less than about 0.1 mm.

19. The wedge structure of claim 17, wherein at least a partial vacuum exists in the at least one cavity.

20. The wedge structure of claim 17, wherein the wedge structure comprises a continuous object-facing surface spanning the transmitting and receiving regions.

21. A method of fabricating an acoustic inspection probe assembly, the method comprising:
modifying a subsurface of a wedge structure using a laser to form a region intermediate a transmitting region and a receiving region, wherein the wedge structure is a monolithic transparent material; and
coupling the wedge structure to a transducer assembly comprising a first linear array of transducer elements and a second linear array of transducer elements.
